(19) United States
(12) Patent Application Publication
(10) Pub. No.: US 2009/0034545 A1
(43) Pub. Date: Feb. 5, 2009

(54) Multicasting

(76) Inventors: Kent E. Biggs, Tomball, TX (US); Michael A. Provencher, Cypress, TX (US); Glenda Sue Canfield, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,136

(22) Filed: Jul. 31, 2007

(51) Int. Cl. H04L 12/28

(52) U.S. Cl. 370/401

(57) ABSTRACT

In one embodiment, a computer system comprises a multicast node to receive a multicast signal indicating a multicast content, in response to the multicast signal, apply a multicast notification signal to at least one remote client managed by the remote computing server, receive, from the at least one remote client, a subscription signal indicating that the at least one remote client subscribes to the multicast content, and in response to the subscription signal, connect the at least one remote client to the multicast node on the remote computing server, whereby the at least one remote client accesses the multicast content.

### BACKGROUND

The term multicast refers to the delivery of information from a source to multiple destinations contemporaneously. Communication networks such as, for example, the Internet, implement multicasting techniques to transmit content from a content source to one or more nodes in the network in a way that does not produce excessive copies of the content.

In some client-server computing environments, remote servers convert multicast content into a separate unicast format for each client that is configured to receive the multicast content. This conversion consumes processing power at the server and consumes bandwidth in the communication networks between the server and the client(s).

### BRIEF DESCRIPTION OF THE DRAWINGS

FIG. 1 is a block diagram of an example client-server computer network architecture according to an embodiment.

FIG. 2 is a block diagram of an example of a network architecture according to an embodiment.

FIG. 3 is a schematic illustration of a system for transmitting multicast content, in accordance with embodiments.

FIG. 4 is a flowchart illustrating operations in a method of multicasting in a computer network.

### DETAILED DESCRIPTION

Disclosed are systems and methods for use in multicasting content via a communication network. In some embodiments, the methods described herein may be embodied as logic instructions on a computer-readable medium. When executed on a processor, the logic instructions cause a computing device to be programmed as a special-purpose machine that may implement the described methods. The processor, when configured by the logic instructions to execute the methods recited herein, constitutes structure for performing the described methods.

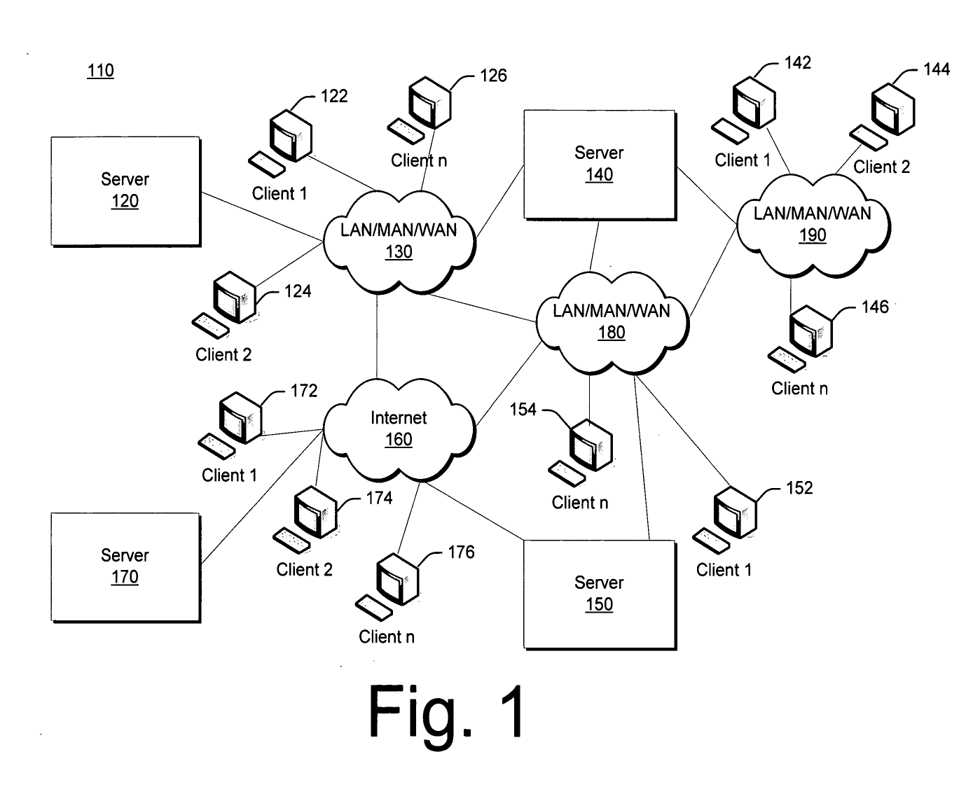

FIG. 1 is a schematic illustration of a block diagram of a computer-based communication network 110. The network 110 is intended to illustrate a conventional client-server network configuration. A server 120 is connected to a plurality of client computers 122,124 and 126 via a communication network 130 such as a Local Area Network (LAN), Metropolitan Area Network (MAN) or a Wide Area Network (WAN) or the like.

The server 120 may be connected to a plurality (n) client computers. Each client computer in the network 110 may be implemented as a fully functional client computer or as a thin client computer. The magnitude of n may be related to the computing power of the server 120. If the server 120 has a high degree of computing power (for example, fast processor(s) and/or a large amount of system memory) relative to other servers on the network, it will be able to effectively serve a relatively large number of client computers.

The server 120 is connected via a network infrastructure 130, which may comprise any combination of hubs, switches, routers and the like. While the network infrastructure 130 is illustrated as being either a LAN, WAN, or MAN, those skilled in the art will appreciate that the network infrastructure 130 may assume other forms such as, e.g., the Internet or any other intranet. The network 110 may include other servers and clients, which may be widely dispersed geographically with respect to the server 120 and to each other to support fully functional client computers in other locations.

The network infrastructure 130 connects the server 120 to server 140, which is representative of any other server in the network environment of server 120. The server 140 may be connected to a plurality of client computers 142, 144 and 146 over network 190. The server 140 is additionally connected to server 150 via network 180, which is in turn is connected to client computers 152 and 154 over network 180. The number of client computers connected to the servers 140 and 150 is dependent on the computing power of the servers 140 and 150, respectively.

The server 140 is additionally connected to the Internet 160 over network 130 or network 180, which is in turn, is connected to server 170. Server 170 is connected to a plurality of client computers 172, 174 and 176 over Internet 160. As with the other servers shown in FIG. 1, server 170 may be connected to as many client computers as its computing power will allow.

Those of ordinary skill in the art will appreciate that servers 120, 140 150 and 170 need not be centrally located. Servers 120, 140, 150 and 170 may be physically remote from one another and maintained separately. Many of the client computers connected with the network 110 have their own CD-ROM and floppy drives, which may be used to load additional software. The software stored on the fully functional client computers in the network 110 may be subject to damage or misconfiguration by users. Additionally, the software loaded by users of the client computers may require periodic maintenance or upgrades.

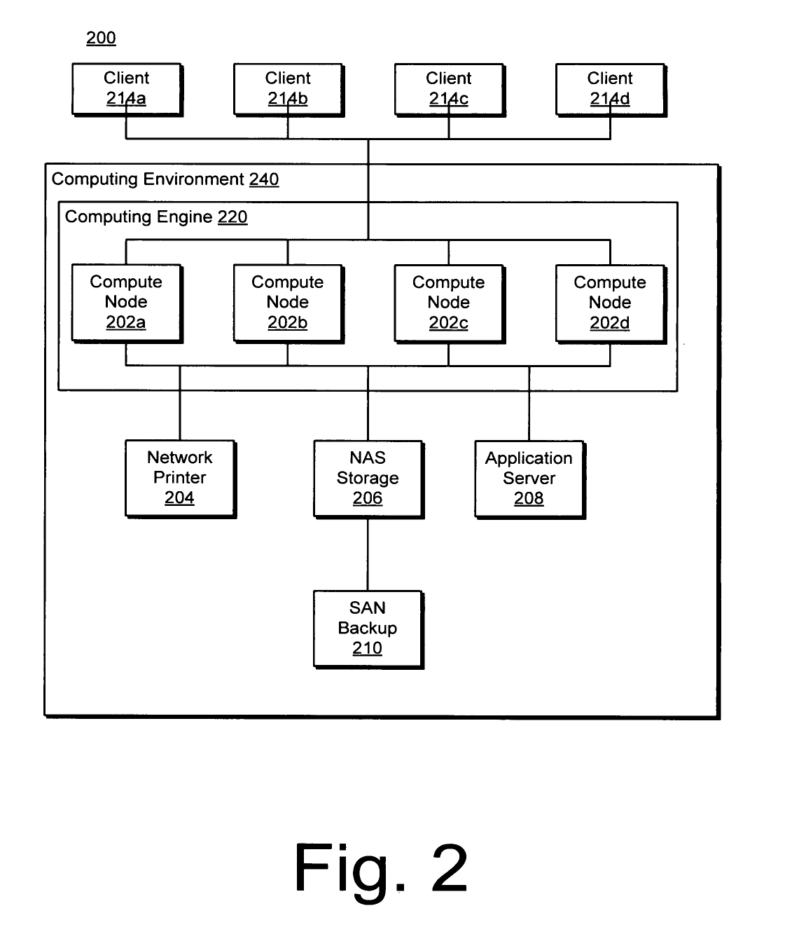

FIG. 2 is a block diagram of an example of a computer network architecture. The network architecture is referred to generally by the reference numeral 200. In one embodiment, a plurality of client computing devices 214a-214d are coupled to a computing environment 240 by a suitable communication network. In some embodiments, the computer network architecture 200 may represent a private network such as, for example, a corporate network.

Within computing environment 240 a plurality of compute nodes 202a-202d are coupled to form a central computing engine 220. Compute nodes 202a-202d may be referred to collectively by the reference numeral 202. Each compute node 202a-202d may comprise a blade computing device such as, e.g., an HP bc1500 blade PC commercially available from Hewlett Packard Corporation of Palo Alto, Calif., USA. Four compute nodes 202a-202d are shown in the computing environment 240 for purposes of illustration, but compute nodes may be added to or removed from the computing engine as needed. The compute nodes 202 are connected by a network infrastructure so that they may share information with other networked resources and with a client in a client-server (or a terminal-server) arrangement.

The compute nodes 202 may be connected to additional computing resources such as a network printer 204, a network attached storage device 206 and/or an application server 208. The network attached storage device 206 may be connected to an auxiliary storage device or storage attached network such as a server attached network back-up device 210.

In some embodiments, the computing environment 240 may be adapted to function as a remote computing server for one or more clients 214. By way of example, a client computing device 214a may initiate a connection request for services from one or more of the compute nodes 202. The connection request is received at a first compute node, e.g., 202a, which processes the request. In the event that the connection between client 214a and compute node 202a is disrupted due to, e.g., a network failure, or device failure, the request may be processed by another compute node such as one of the compute nodes 202b, 202c, 202d.

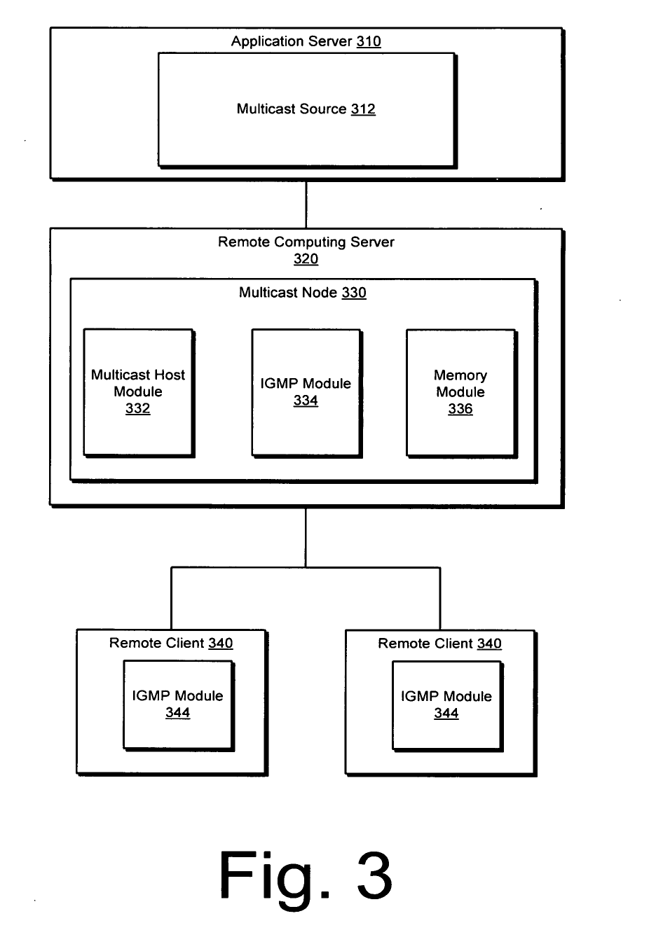

In some embodiments, one or more of the servers and one or more of the clients and communication network 110 may be configured to implement a system for transmitting multicast content. FIG. 3 is a schematic illustration of a system for transmitting multicast content, in accordance with embodiments.

Referring to FIG. 3, the system comprises an application server 310, which in turn comprises a multicast source 312. Application server 310 may correspond to any of the servers 120, 140, 150, 170, depicted in FIG. 1. Application server 310 comprises a multicast source 312, which may be implemented in software, alone or in combination with hardware resources of application server 310.

Multicast source 312 distributes multicast content, for example, in accordance with the IGMP (Internet Group Management Protocol). For example, multicast source 312 may transmit Internet protocol (IP) datagrams to a group of multicast hosts (i.e., a “host group”) identified by a single IP destination address. In addition, multicast source 312 may implement functions of a multicast agent. For example, multicast source 312 may create and maintain host groups.

Application server 310 is coupled to remote computing server 320 by a communication link such as, for example, one or more of the communication networks described above with reference to FIG. 1. Remote computing server 320 may be implemented by a blade computing environment 240 as described with reference to FIG. 2, or by conventional multi-user computer server environment.

Remote computing server 320 comprises a multicast node 330, which may be implemented in software, alone or in combination with hardware resources of remote computing server 320. In the embodiment depicted in FIG. 3, multicast node 330 comprises a multicast host module 332, an IGMP module 334, and may optionally comprise memory module 336. In general, multicast node 330 manages multicast operations within remote computing server 320.

Multicast host module 332 functions as a multicast host. For example, multicast host module 332 may request the creation of new multicast groups and joins or leaves existing groups, i.e., by exchanging messages with a multicast source 312. The multicast source may create a host group in response to the reques from multicast host module 332.

IGMP module 334 may comprise one or more algorithms for receiving multicast content. Memory module 336 may comprise static, dynamic, or persistent memory such as, for example, random access memory (RAM), magnetic memory, optical memory, or the like.

Remote clients 340 may correspond to one or more of the clients depicted in FIG. 1. In some embodiments, remote clients 340 may comprise an IGMP module 344, which enables remote client 340 to receive multicast content.

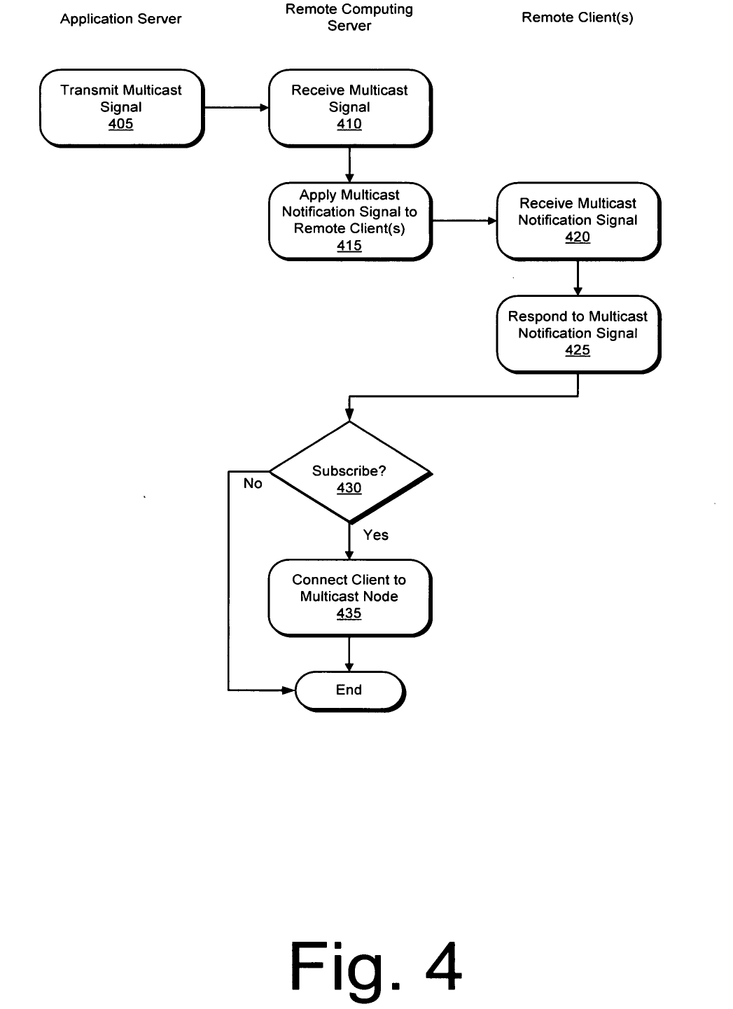

In some embodiments, the system depicted in FIG. 3 may be used for multicasting in a computer network. FIG. 4 is a flowchart illustrating operations in a method of multicasting in a computer network. In some embodiments the operations of FIG. 4 may be implemented by the system depicted in FIG. 3 to implement multicasting.

Referring to FIG. 4, at operation 405 the application server 310 transmits a multicast signal. In the embodiment depicted in FIG. 3, the multicast signal is transmitted by the multicast source 312. In some embodiments, the multicast signal may be transmitted contemporaneously with the transmission of multicast content, while in other embodiments the multicast signal may be transmitted before the transmission of multicast content. The application server 310 may transmit the multicast signal to a plurality of remote computing servers and a host group associated with the multicast content.

At operation 410 the remote computing server 320 receives the multicast signal from the application server 310. In the embodiment depicted in FIG. 3 the multicast signal is directed to the multicast node 330, and more particularly to the multicast host module 332.

In response to the multicast signal, the multicast host module 332 applies a multicast notification signal to one or more remote clients 330 coupled to the remote computing server 320 (operation 415). In some embodiments, the multicast host module 332 may transmit a multicast notification signal to every remote client 340 coupled to remote computing server 320. In other embodiments, the multicast notification signal may be transmitted only to a subset of the remote clients 330 coupled to remote computing server 320.

The multicast notification signal provides an alert to the remote clients 330 that the remote computing server 320 is receiving, or is soon to receive, multicast content from the application server 310. The multicast notification signal may include information which identifies multicast content such as, for example, title information for the multicast content. The multicast notification signal may also include information such as, for example, the duration of the multicast content, a video format associated with the multicast content, and the like.

At operation 420 the multicast notification signal is received at the remote client(s) 330 coupled to the remote computing server 320, and at operation 425 remote client(s) responded to the multicast notification signal. In some embodiments, the multicast notification signal may be presented on a user interface such as, for example, a visual display. A user of the remote client 340 may input a response to the multicast notification signal using a keyboard, mouse, touch screen, or other user interface. In other embodiments, logic in the remote computing server(s) may be configured to accept or reject automatically, or based on rules, multicast content. The response generated by the remote client(s) 340 may include an indication that the remote client wishes to subscribe to the multicast content. In addition, the response may include particular request such as, for example, a request for a delivery of the multicast content at a specific point in time. Further, the response may include an indication that the remote client(s) needs to download additional software in order to view the multicast content. The response may be transmitted to the remote computing server 320 via a communication network.

If, at operation 430, the response from a remote client 340 indicates that the client does not wish to subscribe to the multicast content identified in the multicast notification signal, then processing for that client 340 may end. By contrast, is at operation 430 the response from the remote client indicates that the remote client 340 does wish to subscribe to the multicast content identified in the multicast notification signal, then control passes to operation 435 in the remote client 340 is connected to the multicast node 330.

At this point the remote computing server 320 may implement different operations based upon the information in the response to the multicast notification signal from the remote client. For example, in the event that the response to the multicast notification signal indicates that the remote client 340 lacks software necessary to view the multicast content, the multicast node 330 may initiate a download of an IGMP module to the remote client(s) 340. Further, in the event that the response to the multicast notification signal indicates that the remote client 340 wishes to delay delivery of the multicast content the remote computing server 320 may store all or at least a portion of the multicast content in the memory module 336.

Once the remote client 340 is connected to the multicast node 330 of the remote computer server 320, the multicast content may be forwarded to the remote client 340 in a multicast format. It is not necessary for the remote computing server 322 reformat the multicast content into a unicast format. In some embodiments, the remote computing server 320 may add the remote client 332 the host group for the multicast content delivered by the multicast source 312. In other embodiments, the remote computing server 320 may form and manage a separate host group for the multicast content received by the remote computing server 320. In such embodiments, the multicast source 312 may remain unaware of the remote clients 340.

Thus, the structure depicted in FIG. 3 and the operations depicted in FIG. 4 enable multicast content to be distributed efficiently through remote computing servers to remote clients coupled to the remote computing servers. Advantageously, remote computing servers that service multiple remote clients do not need to convert a multicast content into multiple unicast contents when delivered to individual remote clients. This reduces the processing load on the remote computing server and also reduces bandwidth consumption on the communication networks between remote computing server and the remote clients.

In embodiments, the logic instructions illustrated in FIG. 4 may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is included in at least one implementation. The appearances of the phrase “in one embodiment” in various places in the specification are not necessarily all referring to the same embodiment.

What is claimed is:

1. A method of multicasting in a computer network, comprising:
receiving, in a multicast node on a remote computing server, a multicast signal indicating a multicast content;
in response to the multicast signal, applying a multicast notification signal to at least one remote client managed by the remote computing server;
receiving, from the at least one remote client, a subscription signal indicating that the at least one remote client subscribes to the multicast content; and
in response to the subscription signal, connecting the at least one remote client to the multicast node on the remote computing server, whereby the at least one remote client accesses the multicast content.

2. The method of claim 1, wherein receiving, in a multicast node on a remote computing server, a multicast signal indicating a multicast content comprises receiving a multicast signal from an application server.

3. The method of claim 1, wherein the multicast signal is transmitted contemporaneous with the transmission of a multicast content.

4. The method of claim 1, wherein the multicast signal is transmitted before the transmission of a multicast content.

5. The method of claim 1, wherein connecting the at least one remote client to the multicast node on the remote computing server comprises adding the remote client to a multicast group for multicast content.

6. The method of claim 5, further comprising:
receiving the multicast content in the remote computing server; and
transmitting the multicast content to the at least one remote client.

7. A computer system, comprising a multicast node to:
receive a multicast signal indicating a multicast content;
in response to the multicast signal, apply a multicast notification signal to at least one remote client managed by the remote computing server;
receive, from the at least one remote client, a subscription signal indicating that the at least one remote client subscribes to the multicast content; and
in response to the subscription signal, connect the at least one remote client to the multicast node on the remote computing server, whereby the at least one remote client accesses the multicast content.

8. The computer system of claim 7, wherein the multicast node receives a multicast signal from an application server.

9. The computer system of claim 7, wherein the multicast signal is transmitted contemporaneous with the transmission of a multicast content.

10. The computer system of claim 7, wherein the multicast signal is transmitted before the transmission of a multicast content.

11. The computer system of claim 7., wherein the multicast node adds the remote client to a multicast group for multicast content.

12. The computer system of claim 11, wherein the multicast node:
receives the multicast content in the remote computing server; and
transmits the multicast content to the at least one remote client.

13. A system for transmitting multicast content, comprising:
an application server comprising a multicast source to generate a multicast content for distribution via a communication network;
at least one remote computing server coupled to the communication network and comprising logic stored on a computer readable medium which, when executed by a processor, configures the processor to:
receive a multicast signal indicating the multicast content;
in response to the multicast signal, apply a multicast notification signal to at least one remote client managed by the remote computing server;
receive, from the at least one remote client, a subscription signal indicating that the at least one remote client subscribes to the multicast content; and
in response to the subscription signal, connect the at least one remote client to the multicast node on the remote computing server, whereby the at least one remote client accesses the multicast content.

14. The system of claim 13, wherein the remote computing server receives a multicast signal from an application server.

15. The system of claim 13, wherein the remote computing server is transmitted contemporaneous with the transmission of a multicast content.

16. The system of claim 13, wherein the remote computing server is transmitted before the transmission of a multicast content.

17. The system of claim 13, wherein the remote computing server adds the remote client to a multicast group for multicast content.

18. The system of claim 17, wherein the remote computing server:
receives the multicast content; and
transmits the multicast content to the at least one remote client.

19. The system of claim 17, wherein the remote client receives the multicast content from the remote computing server and presents the multicast content on a display device.
